(19) United States
(12) Patent Application Publication
(10) Pub. No.: US 2022/0366332 A1
(43) Pub. Date: Nov. 17, 2022

(54) SYSTEMS AND METHODS FOR RISK-ADAPTIVE SECURITY INVESTMENT OPTIMIZATION

(71) Applicant: Patrick Duessel, New York, NY (US)

(72) Inventor: Patrick Duessel, New York, NY (US)

(73) Assignee: Riskbeam GmbH, Velten (DE)

(21) Appl. No.: 17/720,049

(22) Filed: Apr. 13, 2022

Related U.S. Application Data
(60) Provisional application No. 63/174,416, filed on Apr. 13, 2021.

(51) Int. Cl. G06Q 10/06; G06Q 40/06

(52) U.S. Cl. CPC G06Q 10/0635; G06Q 40/06

(57) ABSTRACT

A method and system for risk-adaptive security investment optimization using asset-centric risk quantification to estimate risk levels and establish a cyber program that maximizes the impact of cyber spend on risk reduction while taking into account changes in the threat landscape, control environment and infrastructure of an organization. The method and apparatus can be used to identify and measure information security risks across a plurality of information systems based on various estimated losses associated with individual assets, likelihoods of cyber threats applicable to information technology assets in their Computing environment as well as assurance levels of cybersecurity controls to counteract threats. Based on the risks measured the method and apparatus automatically generates a risk-tailored, impact-maximizing security program focusing on systemic and individual control issues in a network of inter-connected assets.

### CROSS-REFERENCE TO RELATED APPLICATIONS

The present application claims priority to U.S. Provisional Application No. 63/174,416 filed Apr. 13, 2021, titled “SYSTEMS AND METHODS FOR RISK-ADAPTIVE SECURITY INVESTMENT OPTIMIZATION,” which is hereby incorporated by reference in its entirety.

### TECHNICAL FIELD

Embodiments of the invention relate generally to systems and methods for risk-adaptive security investment optimization.

### BACKGROUND

Quantitative risk management and portfolio optimization theory have been used for decades in financial services to ensure that risks and the potential loss exposure of an organization's investment portfolio remains within acceptable limits. Value-at-Risk is a commonly used approach to estimate potential financial losses of an organization given normal market conditions within a specified period of time. While Value-at-Risk can be used to understand potential losses in a probabilistic context, portfolio optimization seeks to determine the optimal size of an investment position as part of the portfolio to either minimize the overall volatility of the portfolio or maximize the return on investment of the portfolio.

In the era of digital transformation, the threat of cyber attacks could not be more imminent. Numerous examples of data breaches (e.g.; Solarwinds breach, Microsoft's DNS vulnerability, VMWare ESXi vulnerability) in the past demonstrate how organizations continue to be exposed to a variety of cyber risks. An effective cyber risk management is needed to understand risks and their potential impact on an organization and maintain a security program that is tailored to the risk appetite of the organization. While there are various frameworks, methodologies and industry best practices (e.g.; NIST CSF¹, ISO 270012, FFIEC³) to support risk management in the cyber space, most of them are qualitative in nature and lag consistency and specificity to assess and prioritize risks potentially resulting in biased decision making and consequently inadequate protection of an organization against relevant cyber threats. Cyber risk quantification has emerged over the past years as an alternative to qualitative cyber risk management. Many approaches have been developed (e.g.; FAIR⁴, TARA⁵, OCTAVE⁶). However, one key challenge of existing cyber risk quantification approaches is the lack of methodology to estimate short-term tangible losses and long-term intangible losses (e.g.; loss of trade name value) of an organization as a result of a data breach—a pre-requisite to prioritize cyber risks properly. Another key challenge is a lack of integration with the organization's cyber strategy and program management to optimize the value of the cyber program. The proposed method or apparatus provides a solution to address those key challenges. ¹ National Institute of Standards and Technology Cybersecurity Framework, https://nvlpubs.nist.gov/nistpubs/CSWP/NIST.CSWP.04162018.pdf, last visited Apr. 4, 2021² https://www.iso.org/isoiec-27001-information-security.html, last visited Apr. 4, 2021³ FFIEC Information Technology Examination Handbook Information Security, https://ithandbook.ffiec.gov/media/274793/ffiec_itbooklet_infonmationsecurity.pdf, last visited 04/04/2021⁴ Factor Analysis of Information Risks (FAIR), https://pubs.opengroup.org/onlinepubs/9699919899/toc.pdf, last visited Apr. 4, 2021⁵ Threat Agent Risk Assessment (TARA), https://media10.connectedsocialmedia.com/intel/10/5725/Intel_IT_Business_Value_Prioritizing_Info_Security_Risks_with_TARA.pdf, last visited Apr. 4, 2021⁶ Operationally Critical Threat, Asset, and Vulnerability Evaluation (OCTAVE), https://resources.sei.cmu.edu/asset_files/TechnicalReport/1999_005_001_16769.pdf, last visited Apr. 4, 2021

The ability to quantify cyber risks is an essential pre-requisite to optimize the cyber initiative portfolio of an organization. A lot of research has been done in the field of cyber risk quantification. While there has been a lot of empirical models to measure the impact of data breaches based on externally available data, this section focuses on analytical risk models which integrate vulnerabilities, threats and assets to quantify asset-centric risks to reflect the risk situation of individual organizations.

In BSI⁷ the authors provide a compact and clearly structured introduction to the development of an information security management system (ISMS) in an organization. An ISMS is a planned and organized course of action to achieve and maintain an appropriate level of information security. The guide is based on BSI Standard 200-2 regarding the IT-Grundschutz Methodology and explains elementary steps for reviewing and increasing the information security level. In their work, the authors propose a model that combines assets, threats and mitigations based on standard catalogs. However, the described methodology cannot be used for the quantification of cyber risk or optimization of cyber spend. ⁷ Bundesamt fuer Sicherheit in der Informationstechnik, “Guide to basic protection based on IT-Grundschutz”, https://www.bsi.bund.de/SharedDocs/Downloads/EN/BSI/Grundschutz/Intemational/Basic_Security.html jsessionid=F7FEF56E986479F98EE3BA981BF6541A.internet481?nn=409850, last visited Apr. 3, 2021

In Deloitte⁸ the authors have published high-level articles on cyber risk quantification. Although some of the loss dimensions in the proposed invention are used, the published methods are very high-level and do not explain how to calculate individual financial losses. Their work is also not based on a defined risk model as proposed by this invention and does not address how to optimize security spend. ⁸ https://www2.deloitte.com/us/en/pages/risk/articles/quantifying-cyber-risk-to-chart-a-more-secure-future.html, https://www2.deloitte.com/content/dam/insights/us/articles/quantifying-risk-lessons-from-financial-services-industry/DR19_QuantifyingRisk.pdf, last visited Apr. 3, 2021

In U.S. Pat. No. 10,630,713 the authors propose methods and systems for analyzing and measuring cyber risk using analytical approaches to determine and measure the consequences and/or vulnerabilities to a system (e.g., a computer network, an enterprise network, etc.) due to cyber incidents. By evaluating and quantifying risks associated with several types of cyber incidents and/or security breaches based on a network architecture and/or system design, the cyber risk analysis tool may enable the enterprise leadership to make prudent, informed decisions on how to address individual cyber risks (e.g., determine risk policy) and/or modify existing network deployments or policies. For many institutions, enterprise objective is defined in financial terms, such as budget impact, corporate earnings, impact to balance sheet and/or reputation impact. Thus, the output of the cyber risk analysis tool may be converted to or otherwise expressed as a financial cost in order to provide useful information to decision makers. The method does not allow for calculating risk-optimal cyber initiative portfolios.

A risk model-based approach is considered by Sahinoglu⁹ who proposes a decision tree which is built based on threats and vulnerabilities. Monte-Carlo simulation is used to mimic relationships between vulnerabilities and threats. Expected cost of loss is calculated based on residual risks obtained from the simulation multiplied by capital costs to build assets. The approach does not take into account the environment of an organization and relationships between assets, threats and controls to calculate risks. The proposed method limits losses to capital cost considerations and does not allow for calculation of breach probabilities and probability of attack paths. Furthermore, the method does not allow for calculating risk-optimal cyber initiative portfolios. ⁹ Sahinoglu, M. “Security Meter: A Practical Decision-Tree Model to Quantify Risk.” IEEE Security and Privacy Magazine, 2005

In U.S. Pat. No. 9,747,570 the authors propose a method and system for risk measurement and modeling used to identify and mitigate information security risks for an information system. Risk modelling is based on industry-specific threat likelihood information, the potential business impacts of particular threats, and data on the effectiveness of particular controls implemented by the operators of the information system to calculate residual risk scores for particular risk scenarios. While the approach allows to calculate scores for threat likelihood, business impact and control effectiveness, the method is not asset-centric, does not allow to quantify financial impact values and does not take into account relationships between assets in the environment of the organization to calculate risks, and does not provide means to calculate breach probabilities and security budget allocation.

In Wang¹⁰ authors propose an approach to estimate financial loss based on a Bayesian network approach. The approach uses probability density functions to represent a set of primary loss magnitude random variables for which statistical parameters are obtained through random sampling to construct an approximated quantile distribution function to approximate the total loss value. The proposed method focuses on estimating losses based primary and secondary loss events described by a Bayesian network. However, the authors propose a high-level extension of the model in which threat and controls are incorporated into the Bayesian network. ¹⁰ A Bayesian Network Approach for Cybersecurity Risk Assessment Implementing and Extending the FAIR Model, 2019.

To facilitate rational decision making regarding cyber security investments authors in Sommestad¹¹ present a model-based assessment framework for analyzing the cyber security provided by different architectural scenarios. The framework uses the Bayesian statistics based Extended Influence Diagrams to express attack graphs and related countermeasures. The approach allows calculating the probability that attacks will succeed and the expected loss of these given the instantiated architectural scenario. Method is based on attack-defense graphs and allow to calculate breach probability based on Bayesian statistics. However, approach is not asset centric and does not allow for calculation of risk-optimal security initiative portfolio. ¹¹ Sommestad et al, “Cyber Security Risks Assessment with Bayesian Defense Graphs and Architectural Models”, Proceedings of the 42nd Hawaii International Conference on System Sciences, 2009

In Woods¹² authors investigate how aggregated claims data impacts investments in information security. The authors propose the Iterated Weakest Link Model (IWL) which consists of three components: rules, the strategy adopted and the computation. The rules define whether an attack will take place and the defender's utility conditional on that attack. The strategy determines the defender's choice of defensive configuration across multiple rounds using Monte Carlo methods. Finally, the computation involves calculating the expected utility for adopting each strategy. The approach does not take into account the environment of an organization and relationships between assets, threats and controls to calculate risks. The proposed method limits losses to capital cost considerations and does not allow for calculation of breach probabilities and probability of attack paths. Furthermore, the method does not allow for calculating risk-optimal cyber initiative portfolios. U.S. Patent Publication No. 2018/0025433 and U.S. Pat. No. 9,660,855 also fail to solve the core problems described herein. ¹² Woods et al., “Monte Carlo methods to investigate how aggregated cyber insurance claims data impacts security investments”, 2019 Workshop on the Economics of Information Security, 2018

Thus, it would be beneficial to provide systems and methods for . . . .

### SUMMARY OF THE INVENTION

This summary is provided to introduce a variety of concepts in a simplified form that is disclosed further in the detailed description of the embodiments. This summary is not intended for determining or limiting the scope of the claimed subject matter.

The systems and methods described herein provide a method for identifying information security risks for at least one environment including a set of inter-connected information systems through simulation and optimizing security spend to mitigate identified risks based on a defined risk model. The risk model includes a standardized set of loss dimensions, a standardized set of information technology asset types, a standardized set of cyber threat vectors, a standardized set of security an asset-threat matrix, a threat-control matrix, and control-initiative matrix.

The methods and systems aid in Defined impact models to quantify tangible and intangible losses (e.g. loss of Intellectual property as a result of a breach) based on defined impact models specific to individual losses that may occur as a result of a breach. The user defines risk scenarios, wherein each scenario is tied to applicable loss dimensions and threat vectors providing a scenario-oriented solution. The asset-centric systems and methods utilize generated data to understand network topology and data flows between detected assets. Risk quantification is based all possible attack paths in the environment leading to critical IT assets. Return on investment (ROI) and integrated security investments are optimized based on quantified risk and loss levels leveraging linear programming techniques.

The methods and systems provide risk-adaptive security investment optimization using asset-centric risk quantification to estimate risk levels and establish a cyber program that maximizes the impact of cyber spend on risk reduction while taking into account changes in the threat landscape, control environment and infrastructure of an organization. The method and system can be used to identify and measure information security risks across a plurality of information systems based on various estimated losses associated with individual assets, likelihoods of cyber threats applicable to information technology assets in their Computing environment as well as assurance levels of cybersecurity controls to counteract threats. Based on the risks measured the method and system automatically generates a risk-tailored, impact-maximizing security program focusing on systemic and individual control issues in a network of inter-connected assets.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a flowchart of a method for adaptive risk-based security investment optimization, according to some embodiments;

FIG. 2 illustrates a block diagram of risk model, according to some embodiments;

FIG. 3 illustrates a schematic of the asset-threat matrix, according to some embodiments;

FIG. 4 illustrates a schematic of the threat-control matrix, according to some embodiments;

FIG. 5 illustrates a schematic of the control-initiative matrix, according to some embodiments;

FIG. 6 illustrates a schematic of the mapping loss dimensions to user-defined risk scenarios, according to some embodiments;

FIG. 7 illustrates a screenshot of the cyber risk dashboard management interface, according to some embodiments;

FIG. 8 illustrates a screenshot of the cyber risk dashboard impact analysis interface, according to some embodiments;

FIG. 9 illustrates a screenshot of the cyber risk dashboard risk analysis interface, according to some embodiments;

FIG. 10 illustrates a screenshot of the cyber risk dashboard breach analysis interface, according to some embodiments;

FIG. 11 illustrates a screenshot of the cyber risk dashboard program analysis details interface, according to some embodiments; and

FIG. 12 illustrates a system architecture diagram 100, including a computer system 102, which can be utilized to provide and/or execute the processes described herein in various embodiments.

### DETAILED DESCRIPTION

The specific details of a variety of embodiments described herein are set forth in this application. Any specific details of the embodiments described herein are used for demonstration purposes only, and no unnecessary limitation(s) or inference(s) are to be understood or imputed therefrom.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of action described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

### Terms and Definitions

Asset: Refers to IT asset or Information technology asset.

Threat: An attempt by a threat actor leveraging at least one attack vector to compromise confidentiality, integrity or availability of an information technology asset or IT asset.

Breach: Threat that has materialized to cause a financial, reputational, legal, regulatory or operational impact to the organization due to loss of confidentiality, integrity or availability of information assets or IT assets.

Information technology (IT) asset: Information technology resources including but not limited to users, hardware, firmware, software) such as user, server, hypervisor, client/endpoint, network devices, Internet-of-Things (IoT) devices, embedded controllers, middleware, database, applications, memory, or micro-processors.

Information asset: Information or group of information that can be accessed by, stored by, or processed by an IT asset.

Computing environment: Integrated collection of technology components surrounding an IT asset that serves the needs of its users and the owner of the resulting system.

Threat vector: Means by which a threat actor can gain access to a computer or network in order to deliver a payload or malicious outcome.

Attack path: Path of nodes in a network which a threat actor traverses to compromise confidentiality, integrity or availability of an information asset or IT asset. A node may refer to an individual or IT asset.

### Abbreviations

RMF: Risk Management Framework
NIST: National Institute of Standards and Technology
CSF: Cyber Security Framework
ISO: International Organization for Standardization

According to an exemplary embodiment, and referring generally to the Figures, various exemplary implementations of a method and apparatus for risk-quantified security investment optimization may be disclosed.

The method and apparatus for adaptive security investment optimization is based on a risk quantification framework and a risk model to estimate inherent, current, and target residual risk levels for an organization and to generate a security strategy that maximizes impact and return-of-investment of an organization's cybersecurity program while allowing for adaptation to changes of the organization's threat and control environment.

The risk quantification framework consists of the following components:
Standardized set of loss dimensions including but not limited to primary and secondary impact models and associated parameters to estimate minimum and maximum financial loss based on user-supplied input.
Standardized set of asset types including but not limited to hypervisor, server, endpoint, network devices, Internet-of-Things (IoT) devices, databases, applications and data
Standardized set of cyber threat vectors aligned with standards and industry best practice frameworks such as MITRE ATT&CK framework13.
Standardized set of security controls aligned with standards and industry best practice frameworks, such as NIST Cybersecurity Framework14
Standardized set of cyber initiatives that can be part of a cybersecurity program to improve the organization's cybersecurity capabilities. ¹³ https://attack.mitre.org/¹⁴ https://www.nist.gov/cyberframework

The risk model connects individual components of the risk quantification framework through a set of defined matrices as outlined below. An exemplary illustration of the risk model is provided in Error! Reference source not found.

Asset-Threat matrix maps individual asset types to individual cyber threat vectors. An example is embodied in Error! Reference source not found.

Threat-Control matrix maps individual cyber threats T to individual controls. Correlations between threats and controls in the Threat-Control matrix can be either manually defined by subject-matter expects or empirically determined through analysis of historical data. An example of such mapping is embodied in Error! Reference source not found.Error! Reference source not found.

Control-Initiative matrix maps individual controls to individual cyber initiatives. An example is embodied in Error! Reference source not found.

### Collect Input

A plethora of user-provided information is required to execute the computer program. User input includes key organizational information (i.e.: general financial information such as total annual revenue, profit margin, compound annual growth rate revenue, tax rate, and tax amortization timeline; business information such as business units and revenue share per business unit), risk scenario information (i.e. applicable risk scenarios with description, applicable threats and applicable loss impact factors), control information (i.e. inherent, current and target control assurance or capability maturity levels or system-generated control indicators), threat information (i.e. cyber threat vectors and threat vector likelihoods observed in organization based on interviews or system-generated evidence such as key indicators and metrics) and cyber initiatives (i.e. initiatives and budget allocations). The essential steps of the computer program are outlined below:

### Calculate Impact

As a first step, the potential financial loss is determined based on user-supplied risk scenarios as illustrated in Error! Reference source not found. Each risk scenario describes a threat scenario as well as the potential business impact to the organization in the event of a breach. Each risk scenario includes at least one threat vector (from the risk framework-supplied list of threat vectors T) and at least one pre-defined loss dimension (from the risk framework-supplied loss dimensions L). Each loss dimension is supported by a risk-framework defined specific impact model. Once the user has defined applicable risk scenarios, the user is guided through the configuration of individual financial loss models specific to the user-defined risk scenarios.

As a result of this step, the user is provided with the minimum and maximum financial loss broken down by specific risk scenarios and loss dimensions. An example output is presented in Error! Reference source not found.

### Financial Loss Dimensions

Consider an organization with overall revenue of Iₜₒₜₐₗ which consists of n organizational units, each contributing Iₖ revenue to the total revenue, such that Iₜₒₜₐₗ=Σₖ₌₁ⁿIₖ. Hence, the share sₖ of an organizational unit k to the total revenue is:

$${s}_{k} = \frac{{I}_{k}}{{\sum }_{i = 1}^{n} {I}_{i}}$$

The total potential loss L of an organization as a result of a cyber breach can be composed of primary loss L_{P} and secondary loss L_{S}.

L=L_{P}+L_{S}

While primary loss includes losses directly and immediately related to handling a cyber breach (e.g. forensic analysis, breach notification, repair etc.), secondary and tertiary loss refers to financial loss as the result of the aftermath of the breach over an extended period of time. Primary, secondary and tertiary loss can be further decomposed into individual loss dimensions which are outlined below:

Primary loss dimensions result in increased costs to due activities of an organization to respond to a breach. The impact model includes but is not limited to the following factors: increased costs related to investigate breach L_{Forensics}, increased costs related to notify public L_{Notify}, increased costs to protect customers L_{Protect}, increased costs to re-establish public reputation and trust L_{Comm}, increased costs related to legal representation and settlements with customers and business partners L_{Legal}, increased costs related to regulatory fines and penalties L_{Fines}, increased costs related to restore and improve resiliency of the organization L_{Improve}, increased costs related to insurance L_{Insurance} (e.g. increased premium after claim is made), and increased costs of capital L_{Capital} (e.g. increased interest rates to borrow capital after a breach) and increased cost due to loss of workforce productivity L_{Prod}.

L_{P}=L_{Forensics}+L_{Notify}+L_{Protect}+L_{Comm}+L_{Legal}+L_{Fines}+L_{Improve}+L_{Insurance}+L_{Capital}+L_{Prod}

Secondary loss dimensions are related to a decrease of value of an organization as a result of reputational damage or loss of competitiveness (e.g.; competitor copies intellectual property). The impact model includes but is not limited to the following factors: decreased value related to loss of intellectual property L_{IP}, decreased value related to brand reputation L_{Brand}, and decreased current and future revenue L_{Rev}.

L_{S}=L_{IP}+L_{Brand}+L_{Rev}

Loss of intellectual property and loss of brand value is estimated by calculating the difference between the total present value of after-tax royalty savings (present value of tax amortization benefits) without breach and with hypothetical breach over time interval T (assuming an annual growth rate, and a royalty rate). Decreased current and future revenue L_{Rev} is the result of a deteriorated public reputation (e.g.; decreased sales due to customer attrition or cancellation of future contracts). Loss of revenue is estimated based on current revenue (assuming an annual growth rate r) by calculating the difference between the present value of cash flow after tax amortization benefits without breach and with hypothetical breach over time interval T post breach.

### Analyze Environment

As a second step, the infrastructure environment of the organization is analyzed. Thereby, the user first defines a unique set of environments which can represent network segments or logical groups of assets. The user then has the option to create assets and manually define their relationships/connections in a network graph or upload data from a plurality of data sources (e.g.; network packet capture file, firewall log files, active directory information) covering at least one network segment. Based on the information provided a graph is built which consists of nodes and edges. Nodes represent assets (e.g.; users, laptops, servers, databases, network devices, mobile devices and Internet-of-Things devices) while edges represent relationships between nodes which includes but is not limited to network communication between devices, access of users to individual devices, relationships between individual users. Graph nodes are associated with node types specific attributes. For example, each device (e.g., endpoint, server) is associated with assets attributes including but not limited to “is_critical”, “is_external_facing”, “has_internet_access”.

### Estimate Threat Level

As a third step, at a given point in time, the user provides an estimation for the likelihood for each threat vector in the collective set of threat vectors specified in the user-defined risk scenarios. The Likelihood is estimated based threat event frequency—the number of observations related to a specific threat vector per defined time period annualized over one year. For each threat likelihood the user can choose a confidence level as well as a probability distribution. The confidence level indicates the degree of certainty about a likelihood value which controls the variance of the specified probability distribution during sampling. Threat likelihoods are stored and used to provide recommendations to tune distribution related parameters. The user is required to update threat likelihood parameter on a regular basis (e.g.; quarterly, monthly, weekly, daily). Threat likelihood values are extracted from existing security logs of an organization and standardized and normalized based on threat vectors and threat likelihood range definitions set forth in the risk quantification framework. The user has the ability to manually overwrite recommended parameter values.

### Estimate Control Level

As a fourth step, at a given point in time, the user provides an estimation for the control assurance level for each control from the standardized set of security controls. The control assurance level is estimated based on defined capability maturity level categories or defined security metrics supporting individual controls. Maturity levels are converted to control assurance levels based on a regression function informed by defined key maturity and control level mappings. Alternatively, control levels can be extracted from existing security matrix of an organization, fed by system generated evidence obtained from technical sensors on endpoints and networks, informed by control assurance level definitions set forth in the risk quantification framework. The user has the ability to manually overwrite recommended parameter values.

For each control the user can choose a confidence level as well as a probability distribution. The confidence level indicates the degree of certainty about a control assurance level which controls the variance of the specified probability distribution during sampling. Control assurance levels are stored and used to provide recommendations to tune distribution related parameters.

The user is required to create one inherent control profile, at least one current control profile and one target control profile. The inherent control profile defines the control assurance level prior to implementation of controls at time tstart, the target control profile defines control assurance levels after implementation of controls at time tend, while the current control profile defines control assurance levels after implementation of controls at a point in time ti whereas tstart<ti<tend.

### Calculate Value at Cyber-Risk

As a fifth step, the computer program calculates the value at cyber risk based on inputs provided. Random sampling is performed over N iterations. During each iteration the computer program iterates through each identified path and determines the risk level of each node in the path of the network graph based on the sampled likelihood of threats applicable to the node and sampled current assurance levels of each control applicable to individual threat vectors. The risk score of a node is represented by a combination of attribute values associated with nodes and edges related to the individual node. A node is considered breached if its aggregated risk level exceeds a pre-defined threshold (acceptable risk of exposure level) and all predecessor nodes in the path are considered breached. A matrix is maintained containing the results for each node over all iterations. Based on the breach statistics in the matrix, conditional breach probabilities of individual nodes can be calculated.

### Value at Cyber-Risk

Consider t∈T a random variable contained in a set of statistically independent random variables, each representing a specific cyber threat vector and let gr(t) be a function that maps a specific cyber threat vector to exactly one cyber threat vector group (e.g. “phishing by link” and “phishing by email attachment” are two different cyber threat vectors or methods which are part of the “initial access” tactics and procedures stage as outlined in Error! Reference source not found.). Let ƒₛ(t)∈[0,1] be a function that calculates the likelihood of cyber threat t as the relative annualized frequency of events associated with a specific cyber threat vector t observed in a timeframe s (e.g.; last 30 days) in the environment or at the perimeter of an organization.

Furthermore, let F_{i,S} refer to the distribution of likelihoods of a threat vector ƒₛ(tᵢ) observed over a sequence of timepoints S=(s₀, s₁, . . . , s_{|s|}|s_{I}≥s_{I-1}) described by a probability density function F.

Let c∈C be a random variable in a set of statistically independent random variables, each representing a specific security control. Let q(c) be a function that calculates the assurance level of a control c. Furthermore, the function Q_{j,S} refers to the distribution of assurance levels of a control q(cⱼ) observed over a sequence of discrete timepoints S drawn from a probability distribution which is characterize by a specific probability density function. Let the matrix TC be a R^{N×K} matrix with TC_{i,k}∈[0,1] denoting the relative importance of a control cₖ∈C to counteract a specific cyber threat vector tᵢ∈T, whereas Σₖ₌₁^{K} TC_{i,k}=1.

Furthermore, let AT be a {0,1}^{N×M} binary matrix, ΔT_{i,j}=1 if an individual cyber threat vector tᵢ∈T applies to a specific asset type t(vⱼ) of an asset vⱼ. Asset type can be defined arbitrarily and may represent elementary components in an information technology environment, such as: hypervisor, server, endpoint, Internet-of-Things (IoT) devices, network devices, databases, middleware, applications, and data. An example of asset types and a mapping to applicable cyber threat vectors is embodied in Error! Reference source not found.

Consider a directed acyclic graph G=(V, E, vₛₜₐᵣₜ, V_{end}) defined by a set of nodes V and a set of edges E=V×V with a start node vₛₜₐᵣₜ and a set of terminal nodes V_{end}⊆V. The current risk of exposure Rᵥ (i.e.; residual risk) of a node v∈V in a specific environment can be defined as follows:

$${R}_{v} = \frac{1}{\vert T \vert} [ {\sum }_{i = 1}^{\vert T \vert} {AT}_{i , t ( v )} * \frac{1}{\vert C \vert} [ {\sum }_{j = 1}^{\vert C \vert} {TC}_{i , j} * φ ( {F}_{i , S} * ( 1 - {Q}_{j , S} ) ) ] ]$$

The function φ refers to a normalization function that normalizes the product of threat vector likelihood and control assurance level between [0,1].

Let h(Rᵥ) be a function that determines whether a node v is considered breached based on the overall risk of exposure s of a particular node, whereas τ∈[0,1] denotes a risk threshold:

$$h ( {R}_{v} ) = \{ \begin{matrix}1 , if {R}_{v} \geq τ \\ 0 , otherwise\end{matrix}$$

Let P={pᵢ|p=(vₛₜₐᵣₜ, . . . , vᵢ)}ᵢ₌₁^{|V}^{_{end}}^{|} be the set of all paths pᵢ in a graph G, where pᵢ denotes a finite sequence of edges which joins a sequence of nodes originating in node vₛₜₐᵣₜ and terminating in node vᵢ. A node in the graph is considered breached if and only if the risk of exposure of that node exceeds a predefined threshold and all predecessor nodes in the respective path are considered breached.

### Asset Loss Value

The asset loss value is defined as the estimated worst-case financial loss as a result of a compromised asset. Let S={s, s₂, . . . , sₘ} be a set of risk scenarios. Consider L={l₁, l, . . . , lₙ} be the set of individual loss dimensions and let M be a {0,1}^{n×m} matrix that maps individual loss dimensions to defined risk scenarios. An exemplary mapping is embodied in Error! Reference source not found. The total aggregated risk scenario loss LSᵢ, 1≤i≤m, can then be formulated as:

$${LS}_{i} = {\sum }_{j = 1}^{n} {M}_{j , i} * {L}_{j}$$

Let \hat{V}⊆V denote the set of critical assets discovered in the environment and let A be a {0,1}^{c×m} matrix that maps each asset v∈V to at least one risk scenario. The financial loss Lᵥ attributed to the critical asset v can then be formulated as follows. Lᵥ is the total risk scenario loss LSᵢ with 0≤i≤k, scaled by the revenue share of the organizational unit sᵤ₍ᵥ₎ the asset v is associated with:

Lᵥ=max({LS₀,LS₁,LS₂, . . . ,LSₖ})*sᵤ₍ᵥ₎

Considering the network graph G and the identified set breach paths pᵢ in G, each node z∈pᵢ is also associated with the maximum loss value of all terminal nodes \dot{v}∈\hat{V} that can be reached from z.

### Expected Financial Loss

The expected financial loss is calculated as the loss value which describes the upper bound of loss values in a pre-defined confidence interval (e.g.; 95%) associated with critical assets successfully breached during simulations.

### Optimize Cyber Program

As a sixth step, the computer program optimizes the existing IT security program based on the calculated value at cyber risk and estimated business impact. To this end, the computer program calculates the risk reduction potential of each cyber initiative informed by current and target control assurance levels and asset loss value.

As a result of this step the computer program provides a list of initiatives with recommended budget allocation as well as an overall cyber program health score indicating the degree of alignment of the current cyber program with regard to current risks identified.

### Risk Reduction Potential

The objective of a cyber program is to reduce the overall risk level of an organization. Let I denote the set of all cyber initiatives and P⊆I be the portfolio of ongoing or planned cyber initiatives put in place by an organization to address cyber risks. Let the matrix CI be a R^{M×N} matrix with CI_{j,z}∈[0,1] denoting the relative contribution of an initiative z to improve a control cⱼ∈C, Σ_{z=1}^{|C|}CI_{j,z}=1. Risk can be distinguished between inherent risk, current residual risk and target residual risk.

Inherent risk IR refers to the risk of exposure of an organization in absence of actions to alter risk impact or likelihood (e.g.; before security program is in place). The inherent risk addressed by a particular initiative z can be formulated as follows:

$${IR}_{z} = {\sum }_{v = 1}^{\vert V \vert} {\sum }_{i = 1}^{\vert T \vert} {AT}_{i , t ( v )} {\sum }_{j = 1}^{\vert C \vert} {TC}_{i , j} * {CI}_{j , z} * φ ( {\hat{f}}_{i} * {\hat{q}}_{j} )$$

Current residual risk CRR refers to the risk of exposure of an organization in presence of actions to alter risk impact or likelihood (e.g., during security program). The current residual risk addressed by a particular initiative z can be formulated as follows:

$${CRR}_{z} = {\sum }_{v = 1}^{\vert V \vert} {\sum }_{i = 1}^{\vert T \vert} {AT}_{i , t ( v )} {\sum }_{j = 1}^{\vert C \vert} {TC}_{i , j} * {CI}_{j , z} * φ ( {\hat{f}}_{i} * max ( 0 , {\dot{q}}_{j} - {\hat{q}}_{j} ) )$$

Target residual risk TRR refers to the risk of exposure of an organization accepted by the organization upon successful completion of actions (e.g., upon completion of security program) to alter risk impact or likelihood. The target residual risk addressed by a particular initiative z can be formulated as follows:

$${TRR}_{z} = {\sum }_{v = 1}^{\vert V \vert} {\sum }_{i = 1}^{\vert T \vert} {AT}_{i , t ( v )} {\sum }_{j = 1}^{\vert C \vert} {TC}_{i , j} * {CI}_{j , z} * φ ( {\hat{f}}_{i} * max ( 0 , {\dot{q}}_{j} ) )$$

Current residual risk equals inherent risk upon start of the security program and is expected to converge towards target residual risk level upon completion of the security program.

Risk reduction is dependent on the improvement of control assurance levels driven by initiatives of the security program. Let \hat{ƒ}ⱼ˜F_{i,S} be the estimator for the expected current cyber threat likelihood and \dot{q}ⱼ˜Q_{j,S} be the estimator for the inherent control assurance level of a control cⱼ (i.e., prior to implementation of security program), whereas \ddot{q}ⱼ≥\dot{q}ⱼ denotes the desired target control assurance level (i.e., after implementation of the cyber security program). The potential risk reduction PLR_{z}(t) of a cyber initiative z can then be defined as follows:

$${PLR}_{z} = {\sum }_{v = 1}^{\vert V \vert} {\sum }_{i = 1}^{\vert T \vert} {AT}_{i , t ( v )} {\sum }_{j = 1}^{\vert C \vert} {TC}_{i , j} * {CI}_{j , z} * φ ( {\hat{f}}_{i} * max ( 0 , {\ddot{q}}_{j} - {\dot{q}}_{j} ) ) * {L}_{v}$$

with PLR=Σₜ₌₁^{|T|}Σ_{z=1}^{|P|}PLR_{z} being the total potential risk reduction of an existing security program. The risk reduction gap LRG=L−PLR refers to the potential financial loss not addressed by initiatives of the cyber program and is defined as the difference between the total financial loss estimated and the total risk reduction potential.

Let \hat{q}ⱼ˜Q_{j,S} be the estimator for the current control assurance level of a control cⱼ (i.e., during implementation of security program), whereas \dot{q}ⱼ≤\hat{q}ⱼ≤\ddot{q}ⱼ. The cumulative risk reduction CLR_{z}(t) of a cyber initiative z at time t can then be defined as follows:

$${CLR}_{z} ( t ) = {\sum }_{v = 1}^{\vert V \vert} {\sum }_{i = 1}^{\vert T \vert} {AT}_{i , t ( v )} {\sum }_{j = 1}^{\vert C \vert} {TC}_{i , j} * {CI}_{j , z} * φ ( {\hat{f}}_{i} * max ( 0 , {\hat{q}}_{j} ( t ) - {\dot{q}}_{j} ) ) * {L}_{v}$$

### Security Investment Optimization

Security investment optimization aims at maximizing the gain in terms of risk reduction for a given budget through iterative reduction of the current residual risk towards the target residual risk level accepted by the organization.

The computer program calculates the performance of a cyber initiative year-to-date informed by the cumulative risk reduction (gap addressed between current and target control assurance level) and cumulative budget spend on an initiative year-to-date. The performance of a cyber initiative is expressed by the its financial performance and can be measured in terms of Return on Investment (RoI). The Return on Investment ROI_{z}(t) of an initiative z at time t be defined as follows:

$${ROI}_{z} ( t ) = \frac{( {CLR}_{z} ( t ) - {C}_{z} ( t ) )}{{C}_{z} ( t )} - 1 \leq {ROI}_{z} ( t ) \leq L$$

Considering cost of implementation and operation of cyber initiatives, the slope S_{z}(t) of an initiative z at time t can be defined as a simplified return on investment and formulated as follows:

$${S}_{z} ( t ) = \frac{1}{k} {\sum }_{i = t - k + 1}^{t} \frac{{CLR}_{z} ( i ) - {CLR}_{z} ( i - 1 )}{{C}_{z} ( i ) - {C}_{z} ( i - 1 )} ,$$

0≤S_{z}(t)≤PLR_{z} and k<t, whereas the cost C_{z}=CC_{z}+CO_{z} denotes the total cost to implement and operate an initiative year-to-date, whereas CC_{z}=Σₜ₌₁^{|T|}CC_{z}(t) refers to total accumulated capital expenditures (e.g. investments in buildings, hardware or software) and CO_{z}Σₜ₌₁^{T}CO_{z}(t) denotes the accumulated total operational expenditure year-to-date (e.g. personnel costs, software licenses etc.) to implement and operate cyber capabilities addressed by the initiative. The higher the value the more efficient is the initiative.

Based on the potential risk reduction of individual cyber initiatives and their slope of implementation the computer program calculates the optimal weighting by solving a constraint optimization problem using linear or quadratic programming. The optimal weights calculated represent the recommended budget allocation changes for the reporting period.

The linear program below returns optimal parameters w* to maximize the return on investment of a security portfolio given constraints and parameters.

$${w ( t )}^{*} = arg max \frac{1}{N} {\sum }_{j = 1}^{N} {w}_{j} * {ROI}_{j} ( t ) \\ subject to : \\ {w}_{j} \leq \frac{{PLR}_{j} - {CLR}_{j}}{{\sum }_{i = 1}^{N} ( {PLR}_{i} - {CLR}_{i} )} * b + b * {ξ}_{j} ( t ) \\ {\sum }_{j = 1}^{N} {w}_{j} \leq b \\ {w}_{j} \geq 0.$$

Constraints are designed to a) allocate budget proportional to the potential loss contribution of individual initiatives and b) allocate budget based on the progress history of each initiative. The parameter b represents the current total budget per reporting period available to distribute across the initiatives in the portfolio. The function ξⱼ(t) refers to a reward-penalty function which allows to redistribute budget allocations based on the performance history of individual initiatives and can formulated as follows:

$${ξ}_{j} ( t ) = \{ \begin{matrix}p , if p ( {\dot{r}}_{j} ( t ) ) \geq {q}_{1} \\ - p * \frac{{n}_{1}}{{n}_{2}} , if p ( {\dot{r}}_{j} ( t ) ) \leq {q}_{2}\end{matrix}$$

where

$${\dot{r}}_{j} ( t ) = {S}_{j} ( t ) - \frac{1}{N} {\sum }_{i = 1}^{N} {S}_{i} ( t )$$

refers to the deviation of initiatives slope from the portfolio's average slope at time t, where n₁ refers to the number of initiatives that fall into the upper q₁-quantile and n₂ denotes the number of initiatives that fall into the lower q₂-quantile with 0≥q₂>q₁≥1.

Finally, the computer program provides a sorted list of recommendations based on the risk level of controls associated with an initiative and impact in term of number of nodes to be included in the initiative.

### Risk Alignment Score

The risk alignment score describes the degree of alignment of the current cyber program with regard to present risks identified. Let x be the current budget allocation (in %) across all cyber initiatives and let y be the budget allocation (in %) across all initiatives recommended through solving the optimization problem outlined in this section. The cyber program health score can be calculated as follows:

$$S ( x , y ) = \frac{{x}^{T} y}{\sqrt{{x}^{T} x * {y}^{T} y}}$$

Thereby, the score ranges between zero and one. A score of zero means the cyber program is completely unaligned to address current risks in terms of active cyber initiatives pursued and amount of budget allocated for a particular cyber initiative to address specific risks. A score of 1 in turn means perfect alignment of current activities to address current risks—the cyber program operates the right set of initiatives as well as allocates the right amount of budget for each initiative. The closer a score is to zero the more changes will be required to the existing cyber program to improve effectiveness and efficiency. Recommended detailed activities are outlined by the computer program to effectively and efficiently reduce the current risk reduction potential.

### Generate Report

In the final step, a report is generated and presented to the user. An illustrative version of a generated report is embodied in Error! Reference source not found.—Error! Reference source not found. The table below outlines descriptions of individual elements of a generated report.

| Nr | Title | Description |
|---|---|---|
| A | Financial Analysis | Displays minimum, maximum and expected financial loss as a |
| | | result of a breach. Minimum and maximum loss are determined |
| | | across all user-defined risk scenarios. Expected financial loss is |
| | | obtained through actual breach simulations and accounts for losses |
| | | associated with breached assets. |
| A1 | Minimum | Minimum financial loss across all user-defined risk scenarios. |
| | financial loss | |
| A2 | Maximum | Maximum financial loss across all user-defined risk scenarios. |
| | financial loss | |
| A3 | Expected financial | Upper bound of financial loss observations obtained through |
| | loss | simulation of loss being less or equal to value defined by pre- |
| | | defined confidence level (e.g.; 95%). |
| A4 | Exposure By | Single loss financial loss across all user-defined business units. |
| | Business Unit | |
| A5 | Exposure By Risk | Single loss minimum and maximum financial loss across all user- |
| | Scenario | defined risk scenarios. |
| A6 | Loss Factor | Average share of individual loss factors across all user-defined |
| | Distribution | risk scenarios. |
| A7 | Cost/ Revenue | Expected impact of a data breach across all in scope risk scenarios |
| | Impact | on the organization's cost and revenue projections over an n year |
| | | (e.g.; 5 years) period with minimum and maximum range. |
| A8 | Cash Flow Impact | Expected impact of a breach on the organization's current cash |
| | | flow. Cashflow (CF) is expected to decrease in the event of a |
| | | breach. Based on the simulations the expected loss (as defined in |
| | | A3) is subtracted from the current or projected organization's cash |
| | | flow and divided by the current or projected organization's cash |
| | | flow. Cash Flow inputs are obtained from the organization's |
| | | financial reporting. |
| A9 | Net Profit Margin | Expected impact of a breach on the organization's net profit |
| | Impact | margin. Net Profit Margin (NPM) is expected to decrease in the |
| | | event of a breach. Based on the simulations the expected loss (as |
| | | defined in A3) can be calculate and subtracted from the current or |
| | | projected organization's net profit and divided by the current or |
| | | projected organization's revenue. Net profit margin inputs are |
| | | obtained from the organization's financial reporting. |
| A10 | Quick Ratio | Quick Ratio measures the ability of your organization to meet any |
| | | short-term financial obligations with assets that can be quickly |
| | | converted into cash. This ratio offers a more conservative |
| | | assessment of your fiscal health than the current ratio because it |
| | | excludes inventories from your assets. Like your current ratio, a |
| | | quick ratio greater than 1 indicates that your business is able to |
| | | pay off all of your accounts payable. Quick ratio may be affected |
| | | due to primary or secondary impact of a data breach. Based on |
| | | the simulations the expected loss (as defined in A3) can be |
| | | calculated and added to the current organization's liabilities or |
| | | reducing the organization's assets depending on applicable loss |
| | | dimensions. Quick Ratio inputs are obtained from the |
| | | organization's financial reporting. |
| A11 | EPS Impact | Earning per shares impact. Earnings per share is a company's net |
| | | profit divided by the number of common shares it has outstanding. |
| | | EPS indicates how much money a company makes for each share |
| | | of its stock, and is a widely used metric to estimate corporate |
| | | value. Net income is expected to decrease in the event of a data |
| | | breach due to increased cost of mitigation. EPS inputs are |
| | | obtained from the organization's financial reporting. |
| B | Risk Analysis | Displays risk of exposure (current residual risk) normalized in a |
| | | range between 0 and 1. |
| B1 | Inherent Risk | Inherent risk level as defined in Section 0. |
| | Level | |
| B2 | Residual Risk | Current residual risk level as defined in Section 0. |
| | Level | |
| B3 | Target Risk Level | Target risk level as defined in Section 0. |
| B4 | Completed year- | (B2[i] − B1)/(B3 − B1), where B2[i] is the current residual risk at |
| | to-date | time i |
| B5 | Change since last | B2[i]/B2[i − 1] − 1 |
| | period | |
| B6 | Risk Exposure By | Current residual risk levels across all assets associated with user- |
| | Business Unit | defined business units. |
| B7 | Risk of Exposure | Time series showing historic values of inherent risk level, current |
| | | residual risk level and target risk level |
| B8 | Risk Exposure By | Current residual risk levels across all assets associated specific |
| | Location | location |
| B9 | Risk Exposure By | Current residual risk levels across all assets associated with |
| | Environment | specific environment |
| B10 | Risk Exposure By | Average current residual and target risk levels grouped control |
| | Capability | domains or control categories. |
| B11 | Risk Surface | Risks clustered by threat, control and assets. Each risk cluster is |
| | | represented by an average impact value and an average risk of |
| | | exposure value. The collective set of risk clusters represents an |
| | | risk inventory. |
| C | Breach Analysis | Displays probability of breach averaged over all assets labelled as |
| | | critical by the user. |
| C1 | Number of breach | Number of breach paths identified in which a critical terminal |
| | paths | node in the path of nodes was successfully breached during |
| | | simulation. |
| C2 | Average Breach | Average breach probability across all assets labeled as critical by |
| | Probability | user obtained through simulation. |
| C3 | Critical Assets | Number of critical assets breached divided by the total number of |
| | Breached | the organization's critical assets |
| C4 | Breach Level By | Average breach probability across all critical assets associated |
| | Business Unit | with user-defined business units. |
| C5 | Breach Level By | Average breach probability across all critical assets associated |
| | Location | with a specific location |
| C6 | Breach Level By | Average breach probability across all critical assets associated |
| | Environment | with a specific environment |
| C7 | Assets By Degree | List of assets in breach paths sorted by the outgoing degree in the |
| | | network graph. |
| C8 | Breach Path | All breach paths identified during simulation. A breach path is a |
| | | sequence of nodes which an initial node and a critical terminal |
| | | node. Every node in the breach path is breached at least once. |
| D | Program Analysis | Displays program health score as outlined in Section 0 and |
| | | represents the level of effectiveness and efficiency of an existing |
| | | cyber program to address current risks. The program health score |
| | | is a normalized value between 0 and 1, whereas 0 suggests a cyber |
| | | program is completely unaligned with current risks and a score of |
| | | 1 means the resources invested in specific initiatives adequately |
| | | addresses existing risks. |
| D1 | Alignment of | Program health score as defined in D |
| | program to current | |
| | risks | |
| D2 | Change YTD | Change of program health score compared to initial score |
| | | D1[i]/D1[0] − 1, where D1[i] is the current program health score at |
| | | time i |
| D3 | Change Last | Change of program health score compared to previous reporting |
| | Period | period |
| | | D1[i]/D1i − 10] − 1, where D1[i] is the current program health score |
| | | at time i |
| D4 | Cyber Initiatives | Impact-to-cost ratio of individual cyber initiatives, whereas |
| | By Impact | impact-to-cost ratio is represented as return-on-investment (ROI) |
| | | of individual initiatives. An example of a ROI calculation can be |
| | | found in Section 0. The higher the score the more impactful is the |
| | | initiative to address associated risks. |
| D5 | Risk Alignment − | Displays historic cyber program health scores year to date to |
| | Progress YTD | outline improvement of effectiveness and efficiency of the |
| | | program by adjusting the budget allocations for individual |
| | | initiatives based on their contribution to the remaining risk |
| | | reduction potential. |
| D6 | Current & | Compares current budget allocation of individual initiatives with |
| | Recommended | recommended budget allocation by solving the optimization |
| | Budget Allocation | problem as outlined in Section 0. |
| | (%) | |
| D7 | Recommendations | A list of actionable recommendations outlining key activities |
| | | required for each cyber initiative to achieve the envisioned target |
| | | risk level. Based on the solution of the optimization program as |
| | | outlined in Section 0 recommendations can include: a) Expand |
| | | (expand efforts and resources), b) Reduce (reduce efforts and |
| | | resource), c) Create (set up resources to address new initiative) |
| | | and d) Retire (retire initiative and shift available resources to |
| | | different initiative(s)). |
| D8 | New Initiatives to | Number of initiatives currently not funded with recommendation |
| | create | to establish funding and efforts in the future due to importance of |
| | | initiatives to contribute to overall risk reduction potential. |
| D9 | Existing Initiatives | Number of initiatives currently funded with recommendation to |
| | to expand | increase funding and efforts in the future due to increasing |
| | | importance of initiatives to contribute to overall risk reduction |
| | | potential. |
| D10 | Existing Initiatives | Number of initiatives currently funded with recommendation to |
| | to reduce | decrease funding and efforts in the future due to decreasing |
| | | importance of initiatives to contribute to overall risk reduction |
| | | potential. |
| D11 | Existing initiatives | Number of initiatives currently funded with recommendation to |
| | to retire | retire entirely due to insignificant contribution to overall risk |
| | | reduction potential. |

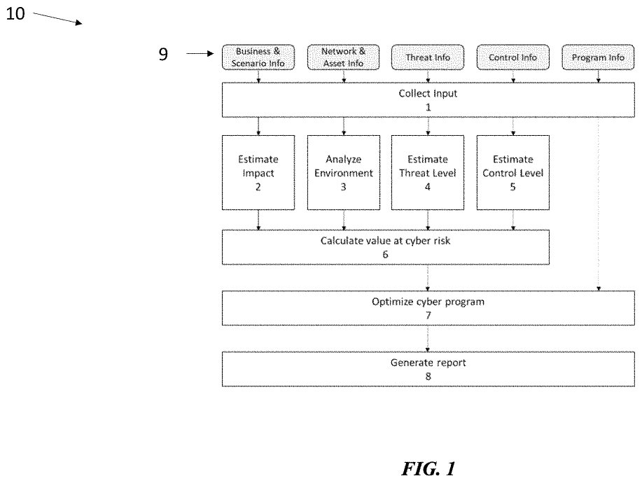

FIG. 1 illustrates a flowchart 10 of a method for adaptive risk-based security investment optimization, according to some embodiments. As shown in the example embodiment, the system can receive or collect input(s) 9 in operation 1, including business and/or scenario information, network and/or asset information, threat information, control information, program information, and/or others. These inputs can then be used in operations to estimate impact 2, analyze environment 3, estimate threat level 4, estimate control level 5, or others. One or more of operations 2-5 can be used to calculate value at cyber risk in operation 6. This calculated value at cyber risk operation 6 and/or inputs collected in operation 1 can be used to optimize a cyber program in operation 7, which can in turn be the basis for generating one or more reports in operation 8.

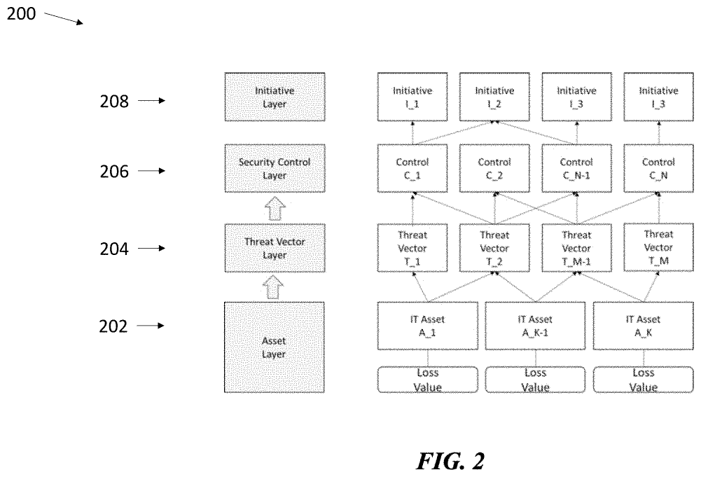

FIG. 2 illustrates a block diagram 200 of risk model, according to some embodiments. As shown in the example embodiment, An asset layer 202 can pass data upward to a threat vector layer 204, which can pass data upward to a security control layer 206. An initiative layer 208 can use data from security control layer 206. Asset layer 202 can include at least one loss value associated with particular IT Assets A_1, . . . , A_K−1, A_K. Data from each IT Asset can be used for at least one Threat Vector T_1, T_2, . . . , T_M−1, T_M. In turn, data from each Threat Vector can be used by for one ore more Control(s) C_1, C_2, . . . , C_N−1, C_N. Finally, initiative(s) I_1, I_2, I_3, . . . can use data from one or more Control(s). A brief example, as shown, could include a loss value being associated with an IT Asset A_1, which can be used for Threat Vectors T_1 and T_2. Each of these Threat Vectors can be used for Control C_1, which may then be used by Initiatives I_1 and I_2. Threat Vector T_2 may also be used by Control C_2, which may not be used by any Initiatives.

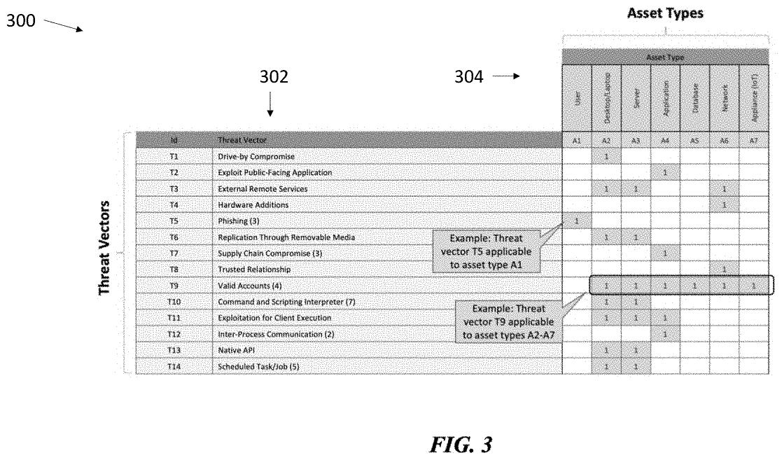

FIG. 3 illustrates a schematic 300 of the asset-threat matrix, according to some embodiments. As shown in the example embodiment, an asset-threat matrix can include one or more threat vector(s) 302, which may each have an ID (e.g. T1, T2, . . . , Tn), and asset types 304, which may have an ID (A1, A2, . . . , Am).

Here, threat vector 302 associations include T1 as Drive-by Compromise, T2 as Exploit Public-Facing Application, T3 as External Remote Services, T4 as Hardware Additions, T5 as Phising (3), T6 as Replication Through Reversable Media, T7 as Supply Chain Compromise (3), T8 as Trusted Relationship, T9 as Valid Accounts (4), T10 as Command and Scripting Interpreter (7), T11 as Exploitation for Client Execution, T12 as Inter-Process Communication (3), T13 as Native API, and T14 as Scheduled Task/Job (5).

Here, asset type 304 associations include A1 as User, A2 as Desktop/Laptop, A3 as Server, A4 as Application, A5 as Database, A6 as Network, A7 as Appliance (IoT).

Boxes in the asset-threat matrix can receive one or more markings or values, depending on conditions. For example, Threat vector T5 has a marking as applicable to asset type A1. Threat vector T9 is marked as applicable to asset types A2-A7.

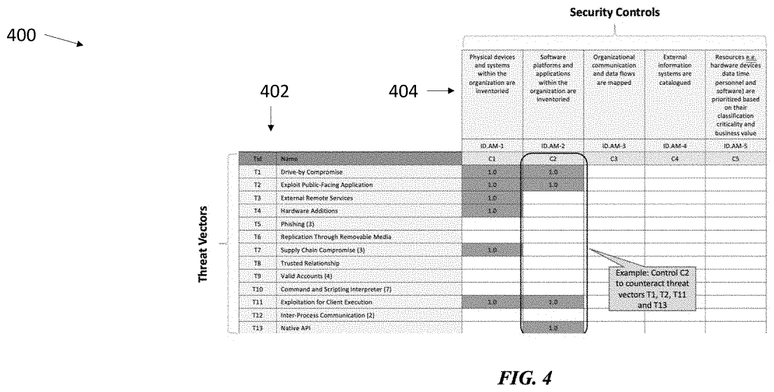

FIG. 4 illustrates a schematic 400 of the threat-control matrix, according to some embodiments. As shown in the example embodiment, a threat-control matrix can include one or more threat vector(s) 402, which may each have an ID (e.g. T1, T2, . . . , Tn), and security controls 404, which may have an ID (ID.AM-1 (C1), ID.AM-2 (C2), . . . , ID.AM-m (Cm)).

Here, threat vector 402 associations include T1 as Drive-by Compromise, T2 as Exploit Public-Facing Application, T3 as External Remote Services, T4 as Hardware Additions, T5 as Phising (3), T6 as Replication Through Reversable Media, T7 as Supply Chain Compromise (3), T8 as Trusted Relationship, T9 as Valid Accounts (4), T10 as Command and Scripting Interpreter (7), T11 as Exploitation for Client Execution, T12 as Inter-Process Communication (3), and T13 as Native API.

Here, security controls 404 associations include ID.AM-1 (C1) as Physical devices and systems within the organization are inventoried, ID.AM-2 (C2) as Software platforms and applications within the organization are inventoried, ID.AM-3 (C3) as Organizational communication and data flows are mapped, ID.AM-4 (C4) as External information systems are catalogued, and ID.AM-5 (C5) as Resources (e.g. hardware, devices, data, time, personnel, and software), are prioritized based on their classification criticality and business value).

Boxes in the threat-control matrix can receive one or more markings or values, depending on conditions. For example, Control C2 can be effective to counteract threat vectors T1, T2, T11, and T13.

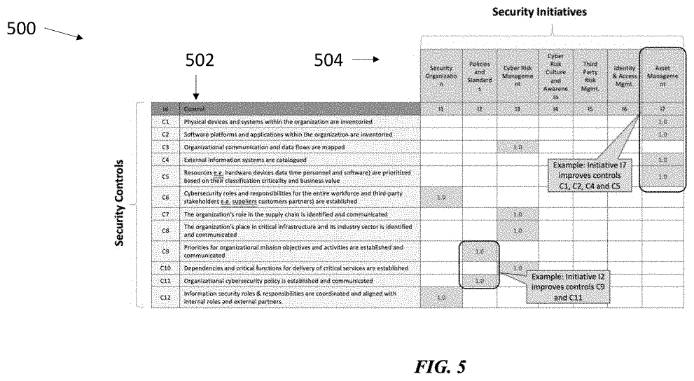

FIG. 5 illustrates a schematic 500 of the control-initiative matrix, according to some embodiments. As shown in the example embodiment, a control-initiative matrix can include one or more security control(s) 502, which may each have an ID (e.g. T1, T2, . . . , Tn), and security initiatives 504, which may have an ID (I1, I2, . . . , Im).

Here, security controls 502 associations include C1 as Physical devices and systems within the organization are inventoried, C2 as Software platforms and applications within the organization are inventoried, C3 as Organizational communication and data flows are mapped, C4 as External information systems are catalogued, C5 as Resources (e.g. hardware, devices, data, time, personnel, and software), are prioritized based on their classification criticality and business value), C6 as Cybersecurity roles and responsibilities for the entire workforce and third-party stakeholders (e.g. suppliers, customers, partners), are established, C7 as The organization's role in the supply chain is identified and communicated, C8 as The organization's place in critical infrastructure and its industry sector is identified and communicated, C9 as Priorities for organizational mission objectives and activities are established and communicated, C10 as Dependencies and critical functions for delivery of critical services are established. C11 as Organizational cybersecurity policy is established and communicated, C12 as Information security roles and responsibilities are coordinated and aligned with internal roles and external partners.

Here, security initiatives 504 include I1 as Security Organization, I2 as Policies and Standard, I3 as Cyber Risk Management, I4 as Cyber Risk Culture and Awareness, I5 as Third Party Risk Management, I6 as Identity and Access Management, and I7 as Asset Management.

Boxes in the control-initiative matrix can receive one or more markings or values, depending on conditions. For example, Initiative I7 can be improve controls C1, C2, C4, and C5. Similarly, Initiative I2 can improve controls C9 and C11.

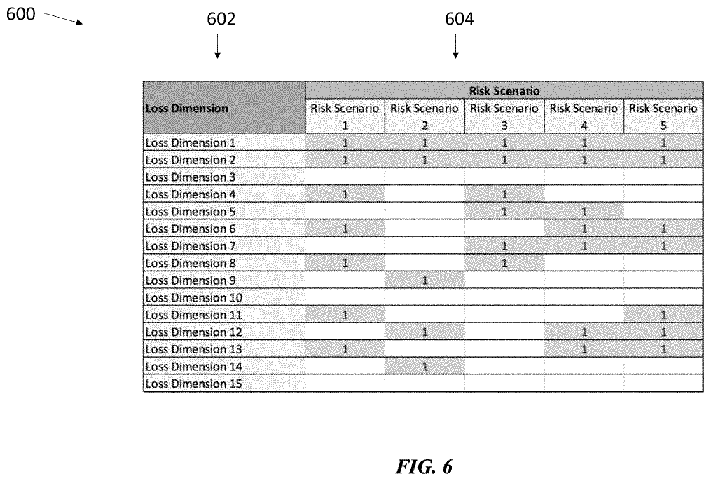

FIG. 6 illustrates a schematic of the mapping loss dimensions to user-defined risk scenarios 600, according to some embodiments. As shown in the example embodiment, Loss Dimension(s) 602 can include Loss Dimension 1 through Loss Dimension n (e.g., Loss Dimension 15) and Risk Scenarios 604 can include Risk Scenario 1 through Risk Scenario m (e.g. Risk Scenario 5). Boxes in the control-initiative matrix can receive one or more markings or values, depending on conditions. For example, Risk Scenario 2 can be affected by Loss Dimension 1, 2, 9, 12, and 14.

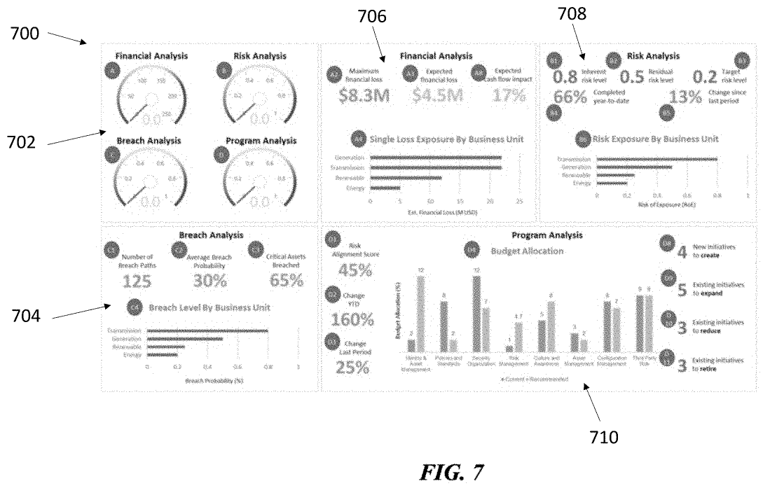

FIG. 7 illustrates a screenshot of the cyber risk dashboard management interface 700, according to some embodiments. As shown in the example embodiment, cyber risk dashboard management interface 700 can include gauges 702, which show a quick snapshot of the analysis of other, more detailed modules. These other modules can also be shown and include Breach analysis 704, Financial analysis 706, Risk analysis 708, Program analysis 710 and/or others.

Breach analysis 704 can include descriptions of a number of breach paths (e.g. 125), an average breach probability percentage (e.g. 30%), a critical assets breach percentage (e.g. 65%), a chart with breach level by business unit breakdown (e.g. by transmission, generation, renewable, energy, or others with probability percentages), and/or others. Financial analysis 706 can include maximum financial loss amount (e.g. $8.3M), expected financial loss amount (e.g. $4.5M), Expected cash flow impact (e.g. 17%), a chart of single loss exposure by business unit (e.g. by transmission, generation, renewable, energy, or others with amounts), and/or others. Risk analysis 708 can include an inherent risk level, completion based on time (e.g. year-to-date), residual risk level, target risk level, change since last period percentage, a chart of single loss exposure by business unit (e.g. by transmission, generation, renewable, energy, or others with risk of exposure (RoE)), and/or others. Program analysis 710 can include a risk alignment score percentage (e.g. 45%), a year to date (YTD) change percentage (e.g. 160%), a change since last period percentage (e.g. 25%), a new initiatives to create quantity, an existing initiatives to expand quantity, an existing initiatives to reduce quantity, an existing initiatives to retire quantity, and a budget allocation chart with current and recommended values, and/or others. In various embodiments, one or more modules or sections can be user selectable and, when selected, may expand or show different screens on the user interface to the user with supplemental, related, and/or supporting information and/or tools.

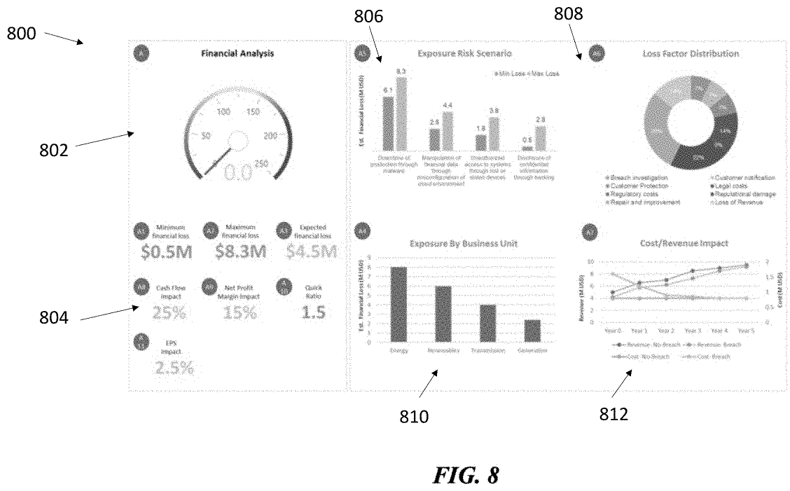

FIG. 8 illustrates a screenshot of the cyber risk dashboard impact analysis interface 800, according to some embodiments. As shown in the example embodiment, a cyber risk dashboard impact analysis interface 800 can include one or more of a financial analysis gauge 802, breakdown 804, exposure risk scenario chart 806, loss factor distribution chart 808, exposure by business unit chart 810, cost/revenue impact chart 812, and/or others. In various embodiments, one or more of these tools or sections can be user selectable and, when selected, may expand or show different screens on the user interface to the user with supplemental, related, and/or supporting information and/or tools. Users can modify time scales, create and/or alter different scenarios and run simulations in various embodiments.

Breakdown 804 can include minimum financial loss amount, maximum financial loss amount, expected financial loss amount, cash flow impact percentage, net profit margin impact percentage, quick ratio, EPS impact percentage, and/or others. Exposure risk scenario chart 806 can include breakdowns of minimum and/or maximum expected loss by different scenarios. Loss factor distribution chart 808 can be a pie chart that shows percentage breakdowns of loss factor contributing factors. Exposure by business unit chart 810 can include a breakdown of financial loss expectations by business unit or sector. Cost/revenue impact chart 812 can include revenue and cost information over a timescale.

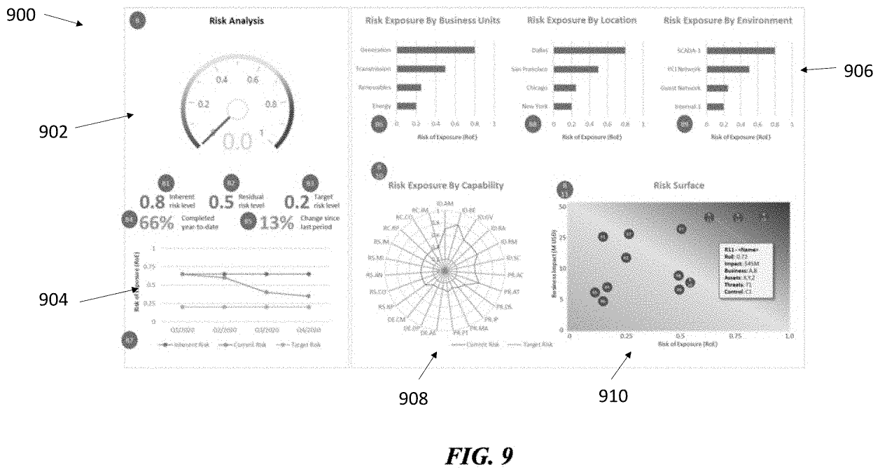

FIG. 9 illustrates a screenshot of the cyber risk dashboard risk analysis interface 900, according to some embodiments. As shown in the example embodiment, a cyber risk dashboard risk analysis interface 900 can include one or more of a risk analysis gauge 902 and related information, risk of exposure chart 904, exposure risk charts 906 (e.g. by business unit, by location, by environment, and/or others), risk exposure by capability chart 908, exposure by risk surface chart 910, and/or others. In various embodiments, one or more of these tools or sections can be user selectable and, when selected, may expand or show different screens on the user interface to the user with supplemental, related, and/or supporting information and/or tools. Users can modify time scales, create and/or alter different scenarios and run simulations in various embodiments.

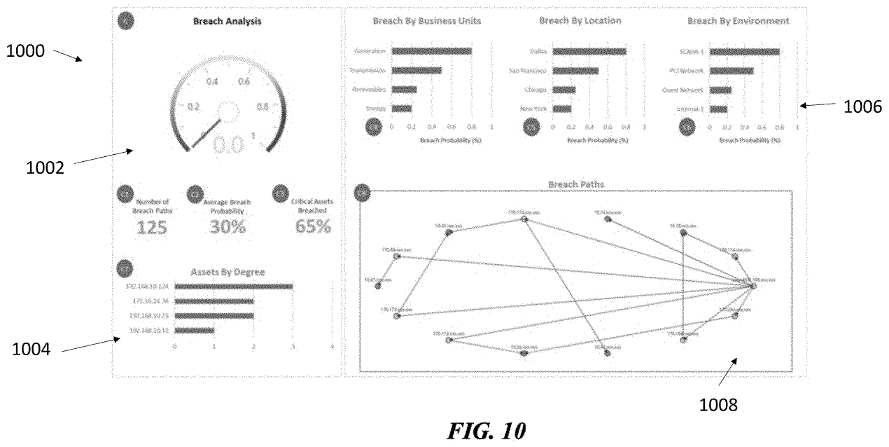

FIG. 10 illustrates a screenshot of the cyber risk dashboard breach analysis interface 1000, according to some embodiments. As shown in the example embodiment, a cyber risk dashboard breach analysis interface 1000 can include one or more of a breach analysis gauge 1002 and related information, assets by degree chart 1004, breach charts 1006 (e.g. by business unit, by location, by environment, and/or others), breach paths chart 1008, and/or others. In various embodiments, one or more of these tools or sections can be user selectable and, when selected, may expand or show different screens on the user interface to the user with supplemental, related, and/or supporting information and/or tools. Users can modify time scales, create and/or alter different scenarios and run simulations in various embodiments.

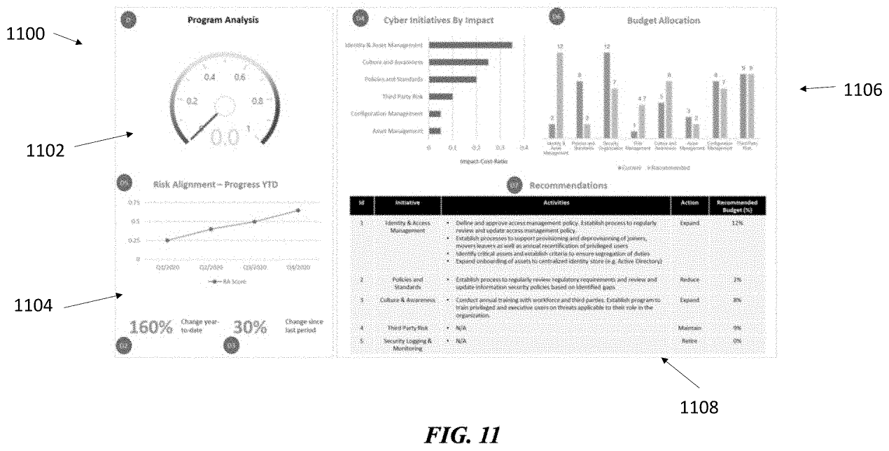

FIG. 11 illustrates a screenshot of the cyber risk dashboard program analysis details interface 1100, according to some embodiments. As shown in the example embodiment, a cyber risk dashboard program analysis details interface 1100 can include one or more of a program analysis gauge 1102 and related information, risk alignment—progress chart 1004 (e.g. by YTD), cyber initiatives by impact and budget allocation charts 1006, recommendations listing 1008, and/or others. In various embodiments, one or more of these tools or sections can be user selectable and, when selected, may expand or show different screens on the user interface to the user with supplemental, related, and/or supporting information and/or tools. Users can modify time scales, create and/or alter different scenarios and run simulations in various embodiments. Recommendations 1108 can include IDs, initiatives, activities, actions, recommended budget percentages, and/or others.

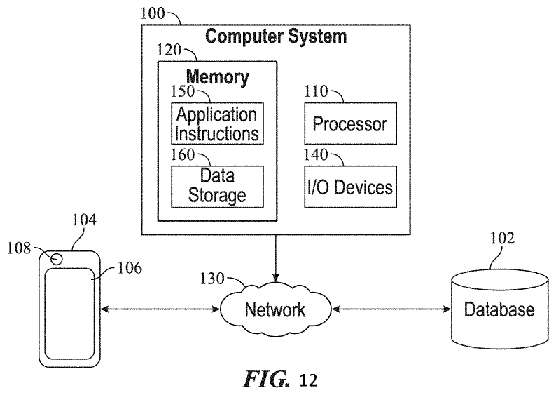

FIG. 12 illustrates a system architecture diagram 100, including a computer system 102, which can be utilized to provide and/or execute the processes described herein in various embodiments. The computer system 102 can be comprised of a standalone computer or mobile computing device, a mainframe computer system, a workstation, a network computer, a desktop computer, a laptop, a tablet, a smartphone, a videogame console, an eBook reader or dedicated digital reader device, or the like. The computer system 102 includes one or more processors 110 coupled to a memory 120 via an input/output (I/O) interface. Computer system 102 may further include a network interface to communicate with the network 130. One or more input/output (I/O) devices 140, such as video device(s) (e.g., a camera), audio device(s), and display(s) are in operable communication with the computer system 102. In some embodiments, similar I/O devices 140 may be separate from computer system 102 and may interact with one or more nodes of the computer system 102 through a wired or wireless connection, such as over a network interface. In many embodiments, computer system 102 can be a server that is fully automated or partially automated and may operate with minimal or no interaction or human input during processes described herein. As such, many embodiments of the processes described herein can be fully automated or partially automated. In instances where a server is provided, connection through network 130 can allow the server to store information in one or more databases that can be used for adaptive learning, artificial intelligence operations, machine learning, or others. Example databases include lesson database(s), client database(s), and others.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 102 and other devices attached to a network 130, such as other computer systems, or between nodes of the computer system 102. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel storage area networks (SANs), or via any other suitable type of network and/or protocol.

The memory 120 may include application instructions 150, configured to implement certain embodiments described herein, and at least one database or data storage 160, comprising various data accessible by the application instructions 150. In at least one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 102 described in connection with the embodiments disclosed herein may be embodied directly in hardware, in a software module executed by a processor, or in a combination of the two. A software module may reside in random-access memory (RAM), flash memory, read-only memory (ROM) memory, erasable programmable read-only memory (EPROM) memory, electrically erasable programmable read-only memory (EEPROM) memory, registers, a hard disk, a solid-state drive (SSD), hybrid drive, dual-drive, a removable disk, a compact disc read-only memory (CD-ROM), digital versatile disc (DVD), high definition digital versatile disc (HD DVD), or any other form of non-transitory storage medium known in the art or later developed. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, Bluetooth, Wi-Fi, microwave, or others, then the coaxial cable, fiber optic cable, twisted pair, DSL, or wireless technologies such as infrared, radio, Bluetooth, Wi-Fi, microwave, or others can be included in the definition of medium. “Disk” and “disc,” as used herein, include compact disc (CD), laser disc, optical disc, digital versatile disc (DVD), floppy disk, and Blu-ray disc or others where disks usually reproduce data magnetically, while discs usually reproduce data optically with lasers. Combinations of the above should also be included within the scope of computer-readable media.

It should be understood by those in the art that computer system 102 also includes power components that are operably coupled such that the system is operable. This can include one or more batteries if computer system 102 is mobile.

In some embodiments, the system is world-wide-web (www) accessible and/or based, and a network server can include a web server delivering HTML, XML, etc., web pages to the computing devices. In other embodiments, a client-server architecture may be implemented, in which a network server executes enterprise and custom software, exchanging data with custom client applications running on the computing device 102.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A computer-implemented method of identifying information security risks for at least one environment comprising a set of interconnected information systems through simulation and optimizing security spend to mitigate identified risks based on a defined risk model, wherein the risk model comprises the steps of:
standardizing a set of information technology asset types, the set of information technology asset types comprising the following: hypervisor, server, endpoint, network devices, Internet-of-Things (IOT) devices, databases, application, data and users;
standardizing a set of cyber threat vectors aligned with one or more industry standards and best practice frameworks;
standardizing set of security controls aligned with one or more industry standards and best practice frameworks;
standardizing a set of financial loss dimensions, comprising primary and secondary loss dimensions, whereas primary loss dimensions are related to increased costs as result of a hypothetical data breach and secondary loss dimensions are related to decreased value of an organization (potentially over a multi-year period) as a result of hypothetical data breach;
standardizing set of cyber initiatives aligned with one or more industry standards and best practice frameworks;
mapping, via an asset-threat matrix, individual information technology asset types to individual cyber threat vectors, wherein associations between information technology asset types and cyber threats in the asset-threat matrix can be either defined manually or empirically through the analysis of historical data;
mapping, via a threat-control matrix, individual cyber threats to individual security controls, wherein associations between cyber threats and security controls in the threat-control matrix can be either defined manually or empirically through analysis of historical data and values in the threat-control matrix can be either discrete or continuous and are normalized by a normalization function such that row sums equal to 1; and
mapping, via a control-initiative matrix, individual security controls to individual cyber initiatives, wherein associations between initiatives and security controls in the initiative-control matrix can be either defined manually or empirically through analysis of historical data and values in control-initiative matrix can be either discrete or continuous and are normalized by a normalization function such that column sums equal to 1.

2. The method of claim 1, wherein the identification of information security risks and optimization of security spend comprises the following steps:
collecting a plurality of inputs, wherein the inputs comprising four components: financial loss information, threat likelihood information, control assurance information and security program information;
determining from a plurality of inputs, cyber risk scenarios applicable to the organization, wherein each cyber risk scenario comprises of at least one cyber threat vector from a pre-defined list of cyber threat vectors and at least one loss dimension from a pre-defined list of financial loss dimensions;
determining from a plurality of assessment activities, the business impact of a potential data breach to the organization as a realization for each defined cyber risk scenario by executing the following steps: Determining current financial performance, comprising: total revenue, earnings before interest and taxes, company annual growth rate, profit margin, of an entity based on collected user input, identify at least one organizational unit of entity, determining organizational unit-specific revenue share (in percent of overall revenue of the entity), determining lower and upper bounds of the financial loss based on pre-defined loss quantification models associated with financial loss dimensions applicable to the cyber risk scenario and collected user input projected over a defined period of time (e.g.; five years) based on the organization's current financial performance indicators (e.g.; year-to-date compound annual growth rate);
determining from a plurality of inputs, the technology environment of the organization by executing the following steps: identifying distinct computing environments, identify and map assets to computing environment, assigning information asset type to individual information technology assets, determining criticality of identified information technology assets, determining internet accessibility of identified information technology assets, determining, with at least one processor, data flows between identified assets, and building a data flow network graph based on identified data flows between information technology assets;
determining and maintaining for each computing environment the threat likelihood related to threats applicable to individual information technology assets, by executing the following steps: estimating current likelihoods of cyber threat vectors based on defined risk model wherein threat likelihood is defined by the number of events related to individual cyber threat vectors observed during a defined period of time t, determining the parameters for a user defined probability density function over individual threat likelihood random variables based on user-supplied input or collected historical data, represented by probability density function specific descriptive statistics (e.g.; mean, variance);
determining and maintaining for each computing environment, the control assurance levels of controls deployed in the computing environment by executing the following steps: estimating the assurance level of controls through control assessment activities based on either a subject-matter expert input or system generated evidence, determining the parameters of a defined probability density function over individual security control random variables, represented by the probability density function specific descriptive statistics (e.g.; mean, variance);
generating, with at least one processor, for each defined cyber risk scenario based on the defined risk model and in-scope information technology assets, cyber threats and security controls, the cyber risk scores, by executing the following steps: assigning identified information technology assets to cyber risk scenario, determining the lower and upper range of financial loss for each critical information technology asset associated with the cyber risk scenario based on the total estimated financial loss associated with the cyber risk scenario, identifying network paths in the data flow network graph leading to critical information technology assets associated with the cyber risk scenario alongside their path probabilities, through repeated sampling calculating risk score for each asset in each identified path as a function of likelihood of asset-specific cyber threats and assurance level of threat-specific controls as defined in the risk model sampled by the respective probability density functions and defined parameters, determining the average risk score for each information technology asset across all repetitions, determining whether the information technology asset is considered breached based on the aggregated risk score and a defined breach threshold, determining the financial loss L_x(t) for each information technology asset determined as “breached”, wherein the financial loss of each information technology asset on a particular network path is represented by the estimated financial loss of the critical information technology asset terminating that attack path;
estimating the expected financial loss across all cyber risk scenarios based on loss values associated with breached information technology assets within a defined confidence level;
generating, with at least on processor, an optimal security investment portfolio representing risk-adjusted weights of security initiatives in the current security program;
generating, with at least on processor, and distributing a report to registered recipients outlining results of the financial impact analysis, risk analysis, breach analysis and cyber program analysis at any given point in time.

3. The method of claim 2, wherein identifying risks comprises of one initial assessment of inherent risk levels, at least one assessment of current residual risk levels and one assessment of target residual risk levels measured across a plurality of security controls for each organization based on a plurality of user inputs and the defined risk model.

4. The method of claim 2, wherein determining the business impact further comprises of determining financial loss of a data breach on an organization as specified by a particular risk scenario across a defined set of primary and secondary financial loss dimensions, resulting in a quantified upper and lower range worst-cast estimations of financial loss between 0 and infinity.

5. The method of claim 4, wherein primary loss dimensions result in increased costs as a result of a data breach and include but not limited to increased costs related to investigate breach L_Forensics, increased costs related to notify public L_Notify, increased costs to protect customers L_Protect, increased costs to re-establish public reputation and trust L_Comm, increased costs related to legal representation and settlements with customers and business partners L_Legal, increased costs related to regulatory fines and penalties L_Fines, increased costs related to restore and improve resiliency of the organization L_Improve, increased costs related to insurance L_Insurance (e.g. increased premium after claim is made), and increased costs of capital L_Capital (e.g. increased interest rates to borrow capital after a breach) and increased cost due to loss of workforce productivity.

6. The method of claim 5, wherein primary impact is calculated by defined impact models with impact-model specific parameters estimated by users comprising: increased costs due to forensic investigations by internal or external resources, increased costs related to notifying individuals about a cyber breach potentially involving the individual, increased costs related to protecting the identity of an individual for lost personal information, increased costs due to re-establishing public trust through digital and non-digital communication activities, increased costs due to legal activities including but not limited to legal representation of an entity and settlement with plaintiffs as a result of a breach, increased costs due to regulatory penalties and fines as a result of a breach, costs related to activities to repair infrastructure and improve security and resiliency through cyber initiatives, increased costs due to borrowing capital as a results of a cyber breach, increased costs of insurance as a result of claims made by the entity and increased cost of productivity.

7. The method of claim 6, wherein impact model-specific parameters for primary impact comprising: increased costs due to forensic investigations includes the following parameters: labor cost per hour, time to investigate incident, increased costs related to notifying individuals about a cyber breach includes the following parameters: number of customers, average cost to notify customer, increased costs related to protecting the identity of an individual includes the following parameters: number of customers, period of protection (in years), customer protection take-up rate (in percent), standard cost to protect single customer per year, discount rate of standard cost (in percent), increased costs due to re-establishing public trust through digital and non-digital communication activities includes the following parameters: time and material costs of external consulting services, cost of communication over digital channels, cost of communication over non-digital channels, size of internal communications workforce in full time intervals, occupation rate of internal workforce during after the cyber breach (in percent), period of communication activities to respond and recover from cyber breach, increased costs due to legal activities include the following parameters: labor cost per hour for external counsel, period of legal representation (in hours), average value of expected settlement, contract penalties imposed by business partners, size of internal legal workforce (in full-time equivalents), occupation rate of internal workforce during after the cyber breach (in percent), increased costs due to regulatory penalties and fines includes the following parameters: total value of fines as a result of non-compliance to applicable laws and regulations, costs related to activities to repair infrastructure and improve security includes the following parameters: number of customers with products involved in breach, average cost to recall product, labor cost to repair IT assets, average time to repair product, number of initiatives required to improve security, average cost per initiative to improve security, increased costs due to borrowing capital includes the following parameters: interest rate prior to cyber breach (in percent), interest rate post cyber breach (in percent), nominal value of capital demand, period of borrowing capital (in years), increased costs of insurance include the following parameters: nominal value of premium cost prior to breach, nominal value of premium post breach, increased costs of productivity include the following parameters: estimated employee productivity level post breach, number of employees affected, average hourly wage per employee, duration of reduced productivity.

8. The method of claim 4, wherein secondary loss dimensions are related to a potentially decrease of value of an organization as a result of a data breach and include but are not limited to decreased value due to loss of intellectual property L_IP, decreased value due loss of brand reputation L_Brand, and decreased value due to loss of current and future revenue L_Rev.

9. The method of claim 8, wherein secondary impact is calculated by defined loss models with impact-model specific parameters estimated by users comprising: decreased intangible asset value of entity due to loss of intellectual property, decreased intangible asset value of entity due to loss of brand value as a result of breach, and decreased revenue due to customer attrition or order cancellation as a result of a breach.

10. The method of claim 9, wherein loss model-specific parameters for secondary impact comprising: decreased intangible asset value of entity due to loss of intellectual property includes the following parameters: revenue growth rate (in percent), product revenue attrition (in percent), devaluation of tradename (in percent), remaining lifetime of intellectual property until deprecation (in years), income tax rate (in percent), royalty rate (in percent), discount rate (in percent), labor cost per hour to restore intellectual property, time to restore intellectual property (in hours), decreased intangible asset value of entity due to loss of brand value includes the following parameters: revenue growth rate (in percent), royalty rate (in percent), devaluation of brand name (in percent), present value factor, income tax rate (in percent), tax lifetime (in years), impact timeline (in years), terminal growth rate (in percent), and expected revenue growth rate (in percent), expected customer attrition rate, impact timeline (in years), discount rate (in percent), income tax rate (in percent), tax lifetime (in years).

11. The method of claim 8, wherein the financial loss as a result of loss of intellectual property, loss of brand value and loss of revenue may be calculated as the difference between discounted cash flows of an organization with and without an assumed breached over a defined impact timeline (in years) based on the loss model-specific parameters for secondary impact.

12. The method of claim 2, wherein the analysis of the technology environment comprises: identifying and maintaining a list of assets of at least one environment by either manual identification of assets, or automated identification of assets utilizing a computer program to analyze system-generate evidences including but not limited to network traffic log files from at least one environment and creating and maintaining a network graph representing relationships between information technology assets located in a computing environment, wherein the network graph can be defined at different levels of resolution by either manual generation of a network graph, or automated generation of a network graph utilizing a computer program to analyze network traffic log files from at least one environment.

13. The method of claim 2, wherein determining the financial loss value of identified assets in at least one computing environment further comprises the steps of: determining critical assets based on financial, regulatory, legal, operational or customer impact requirements, assigning identified critical assets to specific organizational unit based on user input, associating selected assets with pre-defined risk scenarios, using a computer-implemented method to assign lower and upper financial loss value.

14. The method of claim 2, wherein the determination of threat likelihoods further comprises the steps of: determining the number of events related to a cyber threat vector selected from a defined set of threat vectors observed over a given time period either through a) number of cyber threat related events estimated as provided by subject-matter experts or system-generated number of cyber threat related events obtained from a centralized security information and event management platform, converting the number of events into a cyber threat likelihood value by dividing the number of events related to individual cyber threats observed in a given time period by the duration of the time period (days).

15. The method of claim 2, wherein a plurality of controls is defined and each control includes qualitative and quantitative descriptions addressing the level of “control design”, “control implementation”, and “control governance” mapped to a pre-defined control assurance levels between 0 and 1 (e.g.; 0, 0.25, 0.5, 0.75, 1.0), whereas 0 is interpreted as “no control in place” while 1 can be interpreted as “effective control in place”.

16. The method of claim 2, wherein a plurality of controls is defined, and each control includes qualitative and quantitative descriptions addressing the cumulative set of actions to be performed to achieve a desired target state control assurance level from each pre-defined current state control assurance level.

17. The method of claim 2, wherein generating of risk score further comprises: determining risk R_A=L_A×Phi(F(T_A)×G(C_T)) of an individual asset is a function of threat likelihood T_A of threats applicable to the type of information technology asset, transformed by a function F, control assurance level of controls CT applicable to individual threats, transformed by a function G, and loss value L_A of the asset.

18. The method of claim 2, wherein generating breach probability of an information technology asset further comprises: determining breach probability through random sampling over N iterations and applying an activation function F(R_A) on the obtained risk value R_A of an asset given applicable threats and controls in place.

19. The method of claim 2, wherein generating the optimal security investment portfolio further comprises: determining the performance of each cyber initiative as a function of current risk reduction and costs incurred year-to-date.

20. The method of claim 2, wherein generating optimal security investment portfolio further comprises: determining the optimal weight of each cyber initiative by solving a constraint optimization problem that maximizes performance of the entire cyber initiative portfolio, for example measured by return-on-investment, over consecutive reporting periods within a given window and allocating budget to individual initiatives proportional to the remaining amount of potential risk reduction addressed by individual initiatives.

21. The method of claim 20, wherein allocating budget to individual initiatives proportional to the remaining potential risk reduction further comprises: a slack variable for each initiative that is based on a reward-penalty function which allows to lift and shift a percentage of the total budget from low performing initiatives to high-performing initiatives, wherein performance may be measured as historic implementation progress of each initiative, for example measured by the average slope of potential risk reduction over consecutive reporting periods with a given window.

22. The method of claim 2, wherein cyber program analysis includes the calculation of a risk alignment score of a cyber program which describes the degree of alignment of the current cyber program with regard to present risks identified and can be calculated as the normalized inner product of current budget allocation and recommended budget allocation obtained through solving the constraint optimization problem.

23. The method of claim 2, wherein generating optimal security investment portfolio further comprises: predicting or forecasting the impact on the overall risk reduction as a result of increasing or decreasing the existing security budget based on the current spend and budget allocations obtained through solving the constraint optimization problem.
